(19) United States
(12) Patent Application Publication
(10) Pub. No.: US 2003/0204437 A1
(43) Pub. Date: Oct. 30, 2003

(54) Survey data processing

(76) Inventors: Joerg Flender, Wiesloch (DE); Christopher Paul Fastabend, Mannheim (DE); Bernd R. Lehnert, Neustadt (DE)

Correspondence Address: MARK D. KIRKLAND, Fish & Richardson P.C., P.A., Suite 3300, 60 South Sixth Street, Minneapolis, MN, 55402, US

(21) Appl. No.: 10/137,115

(22) Filed: Apr. 30, 2002

(51) Int. Cl. G06F 17/60

(52) U.S. Cl. 705/10

(57) ABSTRACT

A system, method, and computer-readable medium for processing and qualifying multiple data sets supplied by one or more information sources. In certain illustrative embodiments, the invention can be advantageously employed to qualify or classify survey data and, more particularly, generate and categorize leads according to one or more attributes of interest to the data gatherer, such as time sensitiveness. In still other embodiments, a system automatically generates qualified lead profiles based upon responses to an electronic survey.

### TECHNICAL FIELD

The invention relates to the gathering, processing, and classification of data sets such as survey responses.

### BACKGROUND

Companies often gather information in an attempt to learn more about their market, customers, potential customers, and new business opportunities. The gathered information can be utilized to design and direct marketing or sales activities.

Such information can be generated and gathered through customer surveys. The surveys can present various questions about a customer, its needs, its future business plans, its likes, its dislikes, and its opinions about various topics of interest to the surveyor. Surveys are often issued to the parties identified on a lead list or database maintained by the surveyor.

Surveys can be administered in a variety of ways. Surveys may be presented on paper and request the recipient to provide prose answers to various questions. Alternately, a Scantron™ or similar form may be provided, which is suitable for reading by automated equipment. In both the foregoing approaches, large volumes of paper must be printed, handled, organized, analyzed, and processed.

Various electronic data gathering techniques have also been deployed. Computerized surveys may be executed at kiosks or the like. Surveys may also be disseminated by e-mail or presented in HTML format on a website sponsored or maintained by the surveyor. Such techniques can reduce the cost associated with production and dissemination of the survey and the collection of the survey information. They can also reduce the time lag between survey completion and survey data collection. However, the delay associated with processing, analysis and utilization of the survey data often remains.

Typically, electronic survey systems download the survey information into a database that maps survey responses to lead profiles or survey recipient profiles. When the survey information is to be used to generate leads for a sales force, the survey information must be separately processed or evaluated, oftentimes manually, before contact can be made with the respective leads. In certain circumstances, the surveys results or recipient profiles are examined in the order presented in a database report, which can result in an unacceptably long delay before prospective customers in need of immediate assistance are contacted. In other systems, the leads are manually qualified by human analysis before further action is taken. In still other systems, survey recipients are asked to rate their own interest in various products and that information is simply stored in a database to assist the surveyor in its negotiations with the prospective customers.

### SUMMARY

The invention is directed to a system, method, and computer-readable medium for processing and qualifying data sets supplied by one or more information sources. In certain illustrative embodiments, the invention can be advantageously employed to qualify or classify survey data and, more particularly, generate and categorize leads according to one or more attributes of interest to the data gatherer, such as time-sensitivity. In still other embodiments, a system automatically generates qualified lead profiles based upon responses to an electronic survey.

Various embodiments of the invention can be implemented to realize one or more of the following advantages. Certain embodiments automatically and nearly instantaneously identify and tag leads that should be promptly responded to so that they are easily recognized. In some embodiments, leads can be automatically and quickly forwarded to the appropriate group or person within an organization for follow-up activities. Yet another advantage of some embodiments is that lead info can be updated and then automatically forwarded for prompt action.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system for processing survey data embodying the invention;

FIG. 2 is a flow chart of steps that may be performed by a system for processing survey data embodying the invention; and

FIG. 3 is a block diagram of another embodiment of a system for processing survey data.

Like reference symbols in the various drawings indicate like elements.

### DETAILED DESCRIPTION OF ILLUSTRATIVE EMBODIMENTS

Certain embodiments described herein may be used to automatically evaluate gathered information and to tag a lead profile with an attribute that characterizes the lead in one or more relevant respects. For example, upon receipt of a response to a survey from a potential or existing customer, a system can evaluate the survey response according to a qualification algorithm of a desired granularity and then generate and code a lead file, such as a lead object, with an attribute such as time-sensitiveness. Certain embodiments may virtually eliminate the delay associated with data collection, evaluation, and processing by automatically qualifying survey data, generating a nearly instantaneous qualified lead report, and forwarding the qualified lead to one or more agents who can take the appropriate action on the lead.

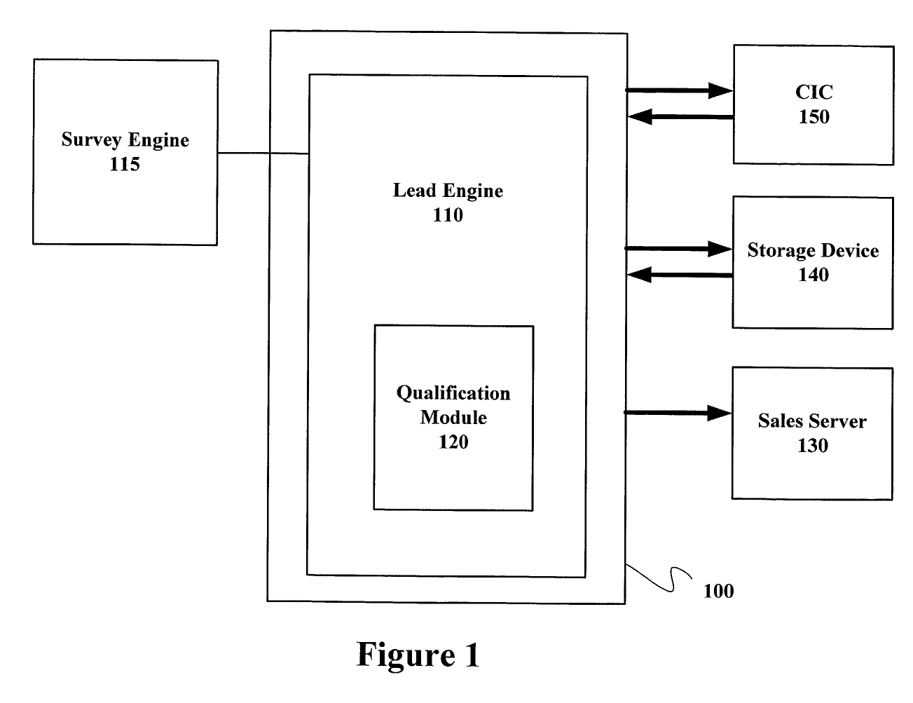

The techniques discussed above can be implemented on a networked system such as that shown in FIG. 1. FIG. 1 shows a platform 100 that can be any suitable computing environment, such as a network server, a node in a local network, a laptop computer wirelessly connected to the appropriate devices, etc. The platform 100 may include a lead engine 110 that qualifies, generates and forwards profiles or other information associated with leads. The lead engine 110 communicates with a survey engine 115 which may upload to the lead engine 110 data associated with responses to an electronic survey form. The lead engine 110 can include a qualification module 120 that applies a qualification protocol to the survey data. The lead engine 110 can transmit information associated with the qualified lead to various network nodes, such as a call center server 150, a long term storage device 140, and a sales server 130.

In various embodiments, the survey engine can communicate survey response data to the lead engine 110 by hardwire network connection, a wireless network, direct serial link from a keyboard, or other known means. In certain embodiments, the survey engine can reside on a personal digital assistant (“PDA”) and the data reflecting survey responses can be transmitted to the lead engine 110 by IR connection, an RF network, or via a cradle connection on a LAN connected to platform 100.

The information transmitted by the survey engine 115 can include a survey value file the content of which indicates the answers given by a recipient to various survey questions. The values can have any desired format, including TRUE/FALSE, integers, ASCII text, and object-based formats. The survey value file can be coded with a survey recipient identifier which uniquely identifies the person who provided the answers reflected in the survey value file. The identifier can map the survey value file to one or more entries in a customer database.

In certain embodiments, the qualification module 120 evaluates the data in a survey value file against an algorithm which determines a relative property of the lead. For instance, the survey questions can be structured so that Boolean TRUE answers, higher integer values, etc. are indicative of a higher level of interest in the topic presented in the survey question. The algorithm may generate a weighted sum of the survey responses, with the weights being applied in proportion to the directness of the correlation between a question and a level of interest in a topic. A lead file can be generated and coded with the value generated by the qualification module. In such an embodiment, a higher qualification value code might indicate a higher level of time-sensitivity or other attribute reflected in the survey responses.

In one embodiment, the qualification module 120 evaluates the relative time-sensitiveness of a sales prospect. The survey questions elicit responses concerning the customer's budget for a project, time frame in which an implementation is desired, the stage of a project's maturity, etc. The algorithm executed by the qualification module 120 assigns a greater weight to the question concerning the time frame in which an implementation is desired, in recognition of the fact that such a constraint drives sales more directly than a consumer's self-evaluation of relative product interest. As will be appreciated by those skilled in the art, the algorithm can be configured so as to evaluate the survey data at any desired level of granularity. For example, the qualification module 120 may be configured to consider only a subset of the survey responses and generate a weighted sum or weighted average of those responses. Regardless of the particular algorithm implemented, the qualification module can generate a value indicative of the degree to which the survey recipient has a desired attribute, such as immediate interest in product purchase. The lead file generated by the lead engine 110 can then be tagged with a time sensitivity value indicative of the time frame in which the prospect should be contacted, and then the platform 100 can route the lead files having the highest time sensitivity values to the sales force server 130, those with lesser time sensitivity values to the call center server 150, and all lead files to the long term storage device 140.

In various embodiments, the survey data upload, qualification, lead generation and transmission may optionally be conducted immediately and nearly instantaneously upon survey completion. In one example, an HTML survey that is submitted electronically on a web-based platform is automatically transmitted to the lead engine 110, which immediately triggers the qualification module. Upon generation of a qualification value, the lead engine 110 generates a lead file and tags or codes it with the appropriate qualification value. The lead engine 110 triggers transmission of the lead file by the platform 100 to sales force server 130, call center server 150, and/or long term storage element 140 based upon the qualification value. Optionally, the sales force server 130 or call center server 150 can automatically and immediately transmit the lead file to one or more company representatives who can take action consistent with a qualification value displayed by a suitable software module.

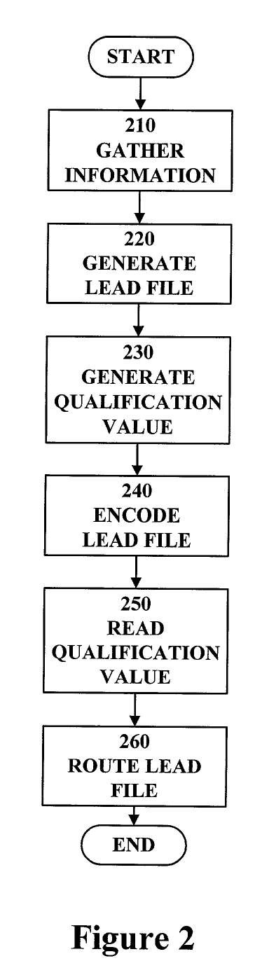

An exemplary operation of the illustrative system of FIG. 1 is described in more detail in FIG. 2. The lead engine 110 gathers information from survey engine 115 at step 210, which information it may process to determine whether the information reflects a potential business opportunity for an enterprise. At 220, the lead engine 110 generates a lead file containing information that identifies the customer, for example, that responded to the survey. The lead file may also contain information from the survey, such as the responses from the customer. In some embodiments, part of a customer's survey response is included in the lead file, for example, those responses that relate to a particular product or service.

At 230, the qualification module 120 can automatically qualify the information, as by the exemplary techniques describe above. The qualification module 120 may analyze the lead to determine if the lead should be pursued, to determine the time frame in which it should be pursued, or to determine some other attribute of interest to the surveyor. After qualifying the lead, the qualification module 120 may generate a qualification value for use by the lead engine 110. The manner of labeling a lead with the qualification value may vary. For example, the lead engine can create a lead file or other electronic object reflecting lead information prior to qualification, after which the qualification module 120 may insert a string into the lead file, which string is readable by the lead engine 110 to indicate that the lead is time sensitive. Alternatively, the qualification module 120 may generate qualification values only for leads determined to have an attribute of interest, such as time-sensitiveness, which may cause the lead engine 110 to take a default action, such as transmission to the call center server 150, for any leads lacking a qualification value. The qualification module 120 may generate the qualification value before the lead engine 110 generates the lead file.

The qualifying engine 120 may evaluate the uploaded survey information using any criteria determined by the enterprise. The qualification module 120 may implement a qualification algorithm having any desired number of parameters and any desired level of statistical sophistication. The qualification module may read the electronic survey data according to any suitable method, such as text string searching, Boolean searching, fuzzy logic, artificial intelligence, etc.

In certain embodiments, the qualification module 120 can extract the responses to one or more queries in the survey and use the response(s) to determine if the survey information reflects a time-sensitive lead. The qualification module 120 can analyze the information in the lead to determine if the information indicates that the individual (or an entity where the individual is employed, for example) plans to make a purchase within two months. If so, and if this is the only criteria for qualifying as a time-sensitive lead, then the qualification module 120 may return the lead to the lead engine as a time-sensitive lead.

Many criteria other than the two-month time frame exemplified above may be used. In qualifying leads, the enterprise may use any criteria that the qualification module 120 can determine is present or absent in the lead. For example, whether the lead indicates that the individual (or entity) has budgeted for an investment in the kind of goods or services offered by the enterprise may be used as a criterion. Moreover, the qualification module may take the size of the allocated budget into account. As another example, the qualification module may analyze the lead for indications that the individual (or entity) has identified a partner, or a sponsor, for a project that potentially involves purchasing goods or services from the enterprise.

Any additional number of parameters or criteria may be used to render a qualification value at a desired level of granularity. For example, the enterprise may decide that an indicated willingness to make a purchase within two months, in combination with an indication of having allocated a budget of a certain size, should qualify as a time-sensitive lead. The qualification module may apply these criteria to the leads in any order and identify leads that satisfy both criteria as time-sensitive leads.

Returning to FIG. 2, the qualification module 120 generates values for use by the lead engine 110 concerning attributes of survey data. As noted above, this may be done in different ways. The lead engine 110 may encode the lead file with the qualification value in step 240. Alternatively, the lead file may be routed using the qualification value without having the qualification value encoded in the lead file.

When the lead engine 110 has generated a lead and the lead has been coded with the corresponding qualification value, the lead engine may forward the time-sensitive lead(s) to a group or person within the enterprise. The lead engine may read the qualification value, step 250 in FIG. 2, to determine the appropriate recipients.

The lead engine 110 may then route the lead file in step 260 to the proper recipient(s). A recipient of the time-sensitive lead, such as a sales department, may use the time-sensitive lead to facilitate an effort by the enterprise to realize the potential business opportunity. Preferably, the lead engine 110 forwards time-sensitive leads for use by the sales department of the enterprise, as schematically illustrated at 130 in FIG. 1. Any known method of communicating the contents of the time-sensitive lead to the sales department may be used. For example, the time-sensitive lead may be forwarded as an electronic message or e-mail.

A system or person who receives the time-sensitive lead may evaluate its contents and may use the time-sensitive lead in an attempt to realize a business opportunity. For example, a time-sensitive lead may be forwarded to a member of the sales department of an enterprise who is responsible for contacts with the enterprise customer with which the time-sensitive lead is associated. Based on the time-sensitive lead, the sales person may approach the enterprise customer and attempt to secure an order from the customer based on the information in the time-sensitive lead.

The lead engine 110 may also store some or all information from the lead, as schematically illustrated by the arrow to storage 140 in FIG. 1. As a result of gathering the information that is contained in the lead, the enterprise may have obtained new information about the entity that the enterprise wishes to make part of its permanent record for that entity. For example, a long term storage 140 may contain a business record for the entity with which a lead is associated, and the lead engine 110 may cause that business record to be revised based on information in the lead. Lead engine 110 may also retrieve information stored in storage 140, as illustrated by the return arrow.

The lead engine 110 may also handle leads that the qualification module 120 has not determined to be time-sensitive leads. The surveyor may decide to process such leads differently than time-sensitive leads. For example, leads tagged with a qualification value reflecting a low product interest might not be immediately pursued because the qualification value is indicative of a small likelihood of realizing any business opportunity. As another example, certain leads may have qualification values which indicate that the lead may turn into a business opportunity in the future. If a survey response indicates an interest from a potential customer in one of the surveyor's products, but it is not considered a time-sensitive lead, the surveyor may follow-up on this lead at a certain time in the future or in a certain manner.

In one example, the system 100 may engage in further processing of a such “intermediate” leads. For example, the lead file may be routed in step 260 for further processing that involves human interaction and analysis, as schematically illustrated by customer interaction center (CIC) server 150 in FIG. 1. An arrow from lead engine 110 to the CIC 150 indicates that the intermediate lead is forwarded to the CIC server 150. For example, an enterprise may decide to further process a lead by having CIC server 150 contact the person from whom the enterprise received the information in the lead. If the information was received in form of a survey response, the CIC may contact the person (or someone else associated with a company where the person is employed). Any additional information obtained by CIC 150 may be provided to the lead engine 110, as indicated by the return arrow in FIG. 1. The lead engine 110 may update the lead with the additional information and forward the updated lead to qualification module 120 to determine if the updated lead is a time-sensitive lead. Based on a revised qualification value in the lead file, the lead engine 110 may then forward the time-sensitive lead as described above.

When the survey responses are gathered from individuals, the leads may also comprise information on an entity or entities with which the individuals responding to the survey are associated. For example, each lead may include a response to a survey and a business record reflecting the company where the person responding to the survey is employed.

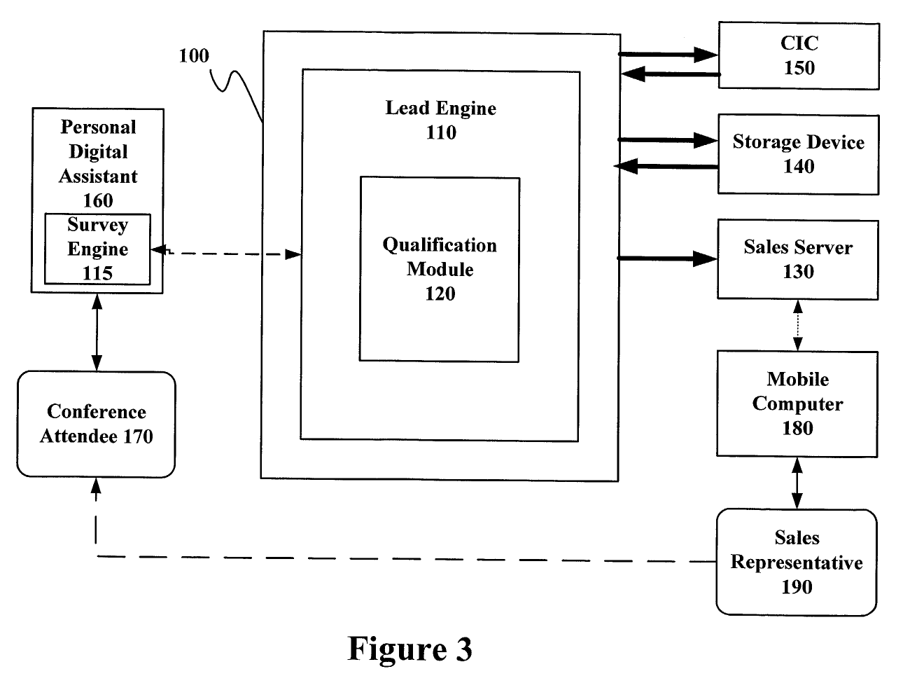

The operation of another embodiment of the inventive system will now be described with reference also to FIG. 3. Some components have the same reference numerals as in FIG. 1 and will not be specifically described here. In this embodiment, the survey engine 115 is contained in a PDA 160, such as a PALM device. The PDA 160 may, for example, connect wirelessly to lead engine 110. The survey engine 115 may present the survey query or queries on the display of the PDA 160 for a conference attendee 170 to read. The conference attendee 170 may respond to the query by entering information into the PDA 160 and submit the response to the lead engine 110.

Qualification module 120 may process the survey response by one or more algebraic algorithms. In this exemplary embodiment, the survey comprises two questions, Q1 and Q2, and each question is weighted by an integer. Q1 has weight 2. Question Q1 is a single choice with two possible entries “YES” and “NO”. Each answer has a value and the possible scores for a question are the answer values multiplied by the question weight. In this example, answer “YES” has the value 1 and the answer “NO” has the value 0. Accordingly, the possible scores for question Q1 are 0 (the value 0 times the weight 2) and 2 (the value 1 times the weight 2).

Question Q2 has the weight 1 and has answer choices “NO ENTRY”, “RED”, “GREEN” and “BLUE”. The answer choices “RED”, “GREEN” and “BLUE” are not exclusive and the attendee 170 may enter more than one choice. The values for the answer choices are, respectively: NO ENTRY=0, RED=1, GREEN=2 and BLUE=3. Thus, the possible scores for question Q2 are the integers 0, 1, 2, 3, 4, 5 and 6. Consequently, the score of the total survey (Q1 and Q2) may range from 0 to 8, because the lowest sum of the Q1 score and the Q2 score is 0+0=0, and the highest sum of the Q1 score and the Q2 score is 2+6=8. The qualification module 120 may use the survey score to give the lead one qualification value for a survey score of 2 or less, another qualification value for survey scores of 3 or 4, and yet another qualification value for survey scores of 4 to 8. The lead engine 110 reads the qualification value for the lead and may route leads differently based on different qualification values. For example, in this embodiment, a lead with a survey score of 4 to 8 may be designated as a time-sensitive lead.

If the lead received from the conference attendee 170 is time-sensitive, the lead engine 110 may forward the lead for prompt follow up by a suitable recipient. Such a lead may contain at least part of the attendee's survey response and a customer record of the attendee's company. Sales server 130 may receive the lead from lead engine 110 and forward it to mobile computer 180. Sales server 130 may connect to mobile computer 180 for example by wireless communication. In the mobile computer, the lead may be accessed by sales representative 190 who may decide to quickly follow up on the lead by contacting the attendee 170 (or the customer company) as indicated by the arrow in FIG. 3.

Those skilled in the art will recognize that the aforementioned techniques and systems can be implemented in a variety of advantageous manners. The survey engine can be any suitable customer interface, such as paper forms, person-to-person interviews, web-based surveys, PDAs, cell phones implementing voice driven surveys, and personal computers of all varieties. The survey form can have any desired format, including but not limited to XML, HTML, a visual basic compatible format, and rich text format. Any number of questions can be posed in the survey and answers can be selected from options presented in drop-down boxes or check boxes, answers can be entered manually, etc. The various components described above need not be electronic. They may likewise communicate or interact via any suitable means, such as mail, e-mail, hardwire connection, wireless network, cellular network, or the like. The lead profiles can be transmitted to and further processed by any desired number of recipients in any order or combination. The follow-up on a lead can be completely automated if desired, thereby permitting follow-up contact to be made within a matter of seconds of survey completion in certain embodiments. The process described in FIG. 2 is merely exemplary, and the various steps set forth therein can be performed in any desired order.

It will be further understood that the foregoing techniques can be implemented to gather and classify data sets of any origin. For example, data describing a population of job applicants can be sorted and classified according to a desired set of parameters, such as ranking of educational institution, grade point average, relevance of work experience, etc. In a like manner, other data sets can be classified or qualified in a desired manner by application of a suitable qualification algorithm.

A number of embodiments of the invention have been described. Nevertheless, it will be understood that various modifications may be made without departing from the spirit and scope of the invention. Accordingly, other embodiments are within the scope of the following claims.

What is claimed is:

1. A method of classifying a survey response, comprising:
gathering survey data reflecting at least one response to a survey query, said survey data including an identifier related to an entity that provided the response;
generating a lead file containing information identifying the entity that provided the response;
generating a qualification value indicative of an attribute by statistically correlating the response with the attribute;
reading the qualification value; and
routing the lead file based on the qualification value.

2. The method of claim 1, further comprising encoding the lead file with the qualification value.

3. The method of claim 2, wherein the qualification value is read in the lead file.

4. The method of claim 1, wherein the entity is a customer or potential customer.

5. The method of claim 1, wherein the lead file is generated after the qualification value.

6. The method of claim 1, wherein the response includes a value which reflects an answer to a survey question.

7. The method of claim 1, wherein the identifier identifies an entry in a customer database.

8. The method of claim 1, wherein the qualification value is generated by taking a weighted average of a plurality of responses in the survey data.

9. The method of claim 1, wherein the lead file is encoded with an integer qualification value and wherein a higher integer value reflects a stronger correlation between the survey response and one or more attributes of interest.

10. The method of claim 1, wherein the qualification value indicates time sensitiveness or product interest.

11. The method of claim 1, wherein routing the lead file comprises selectively forwarding the lead file to a sales representative.

12. The method of claim 1, wherein the lead file is generated, qualified and routed automatically after receipt of the survey data.

13. The method of claim 1, wherein the lead file further comprises at least part of the survey data.

14. A system for classifying a survey response comprising:
a lead engine to receive and process data reflecting at least one response to a survey and to selectively forward a lead file based upon a qualification value associated with the lead file;
a qualification module to statistically correlate the response with one or more attributes and generate the qualification value based on that correlation; and
a plurality of recipients to selectively receive the lead file based on the qualification value.

15. The system of claim 14, further comprising a survey engine to execute the survey.

16. The system of claim 15, wherein the survey engine resides on a personal digital assistant.

17. The system of claim 15, wherein the survey engine periodically establishes wireless connection to the lead engine.

18. The system of claim 14, wherein the qualification module applies an algorithm that determines a time-sensitivity of the response.

19. The system of claim 14, wherein the qualification value is an integer and wherein the qualification value is to be encoded within the lead file.

20. The system of claim 14, further comprising a sales force server or sales force representative to selectively receive lead files having qualification values within a predetermined range.

21. The system of claim 15, wherein the qualification module, survey engine, and lead engine all reside on separate platforms that are at least intermittently connected through a network.

22. The system of claim 14, wherein the lead file includes an identifier which maps the lead file to one or more entries in a customer database.

23. The system of claim 14, wherein the lead engine and qualification module are configured to automatically generate and transmit a qualified lead upon receipt of the response.

24. Computer-readable medium having stored thereon instructions that when executed perform the following functions:
gathers survey data reflecting at least one response to a survey query, said survey data including an identifier related to an entity that provided the response;
generates a lead file containing information identifying the entity that provided the response;
generates a qualification value indicative of an attribute by statistically correlating the response with the attribute;
reads the qualification value; and
routes the lead file based on the qualification value.

25. The computer-readable medium of claim 24, further comprising the function encoding the lead file with the qualification value.

26. The computer-readable medium of claim 25, wherein the qualification value is read in the lead file.

27. The computer-readable medium of claim 24, wherein the qualification value is generated by taking a weighted average of a plurality of responses in the survey data.

28. The computer-readable medium of claim 24, wherein the lead file is encoded with an integer qualification value and wherein a higher integer value reflects a stronger correlation between the survey response and one or more attributes of interest.

29. The computer-readable medium of claim 24, wherein the qualification value indicates time sensitiveness or product interest.

30. The computer-readable medium of claim 24, wherein routing the lead file comprises selectively forwarding the lead file to a sales representative.

31. The computer-readable medium of claim 24, wherein the lead file is generated, qualified and routed automatically after receipt of the survey data.
